(19) United States
(12) Patent Application Publication
(10) Pub. No.: US 2008/0120338 A1
(43) Pub. Date: May 22, 2008

(54) TRIGGER FOR TARGETED BRUTE FORCE SYNCHRONIZATION IN A UPNP CLIENT-DRIVEN SYNCHRONIZATION MODEL

(75) Inventor: Adrian Constantin, Helsinki (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/562,891

(22) Filed: Nov. 22, 2006

(51) Int. Cl. G06F 17/00

(52) U.S. Cl. 707/104.1

(57) ABSTRACT

A system for improved synchronization with regard to changes in a CDS media library. A property is added to the LastChange state variable that indicates a particular container to which changes have been made. Information can also be appended to the state variable indicating whether there have been additions, deletions, or other types of changes to the appropriate sub-tree container. This new property triggers a control point to browse and search in order to obtain a complete list of changes. In a particular embodiment, this trigger is only added to objects for which it is impractical to deliver the entire list of changes via notifications.

### FIELD OF THE INVENTION

The present invention relates generally to Universal Plug and Play (UPnP) technology. More particularly, the present invention relates to the detection of changes in a UPnP Audio Video Architecture (AV) media library.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

UPnP technology defines an architecture for pervasive peer-to-peer network connectivity of intelligent appliances, wireless devices, and personal computers of all form factors. UPnP technology is designed to bring easy-to-use, flexible, standards-based connectivity to ad-hoc or unmanaged networks whether in the home, in a small business, in public spaces, or attached to the Internet. UPnP technology provides a distributed, open networking architecture that leverages TCP/IP and Web technologies to enable seamless proximity networking, in addition to control and data transfer among networked devices.

The UPnP AV defines how media devices, i.e., servers, renderers and control points (CPs), can communicate with each other for the distribution and consumption of content. The UPnP AV Content Directory Service (CDS) defines a lookup/storage service for home users' content and a uniform mechanism for user interface (UI) devices to browse the content on the server and obtain detailed information about individual content objects.

In the third release of the CDS (CDS:3), new mechanisms have been proposed that would allow CPs to easily detect changes in the media library of the CDS and to be notified about the changes. These notifications involve the use of a state variable referred to as LastChange. The LastChange state variable stores a list of all of the changed objects in the CDS. The LastChange state variable is transferred through the network as an XML fragment, having a StateEvent element as a root. For each object that has changed in the CDS structure, the StateEvent element contains one of the following elements: ObjectCreated, ObjectModified, ObjectDeleted.

One issue surrounding the use of the LastChange state variable involves the amount of memory that is consumed. The memory consumed for storing and encoding the LastChange state variable as an XML fragment can grow to a very large inconvenient size in certain conditions. For example, when there are a large number of changes over a short period of time, or when there is a long period of time between notifications due to the absence of CDS subscribers (CPs), the LastChange state variable can become very large. The situation becomes worse when such a big notification has to be delivered to multiple subscribers. This issue can become particularly pronounced in mobile UPnP devices, such as mobile telephones, which generally have a relatively low amount of available memory at their disposal.

It would therefore be desirable to provide a system that can help to reduce such large memory requirements.

### SUMMARY OF THE INVENTION

Various embodiments of the present invention provide a system for improved synchronization with regard to changes in a CDS media library. According to the various embodiments, a new property is added to the LastChange state variable. This new property triggers a control point to browse and search in order to obtain a complete list of changes. In a particular embodiment, this trigger is only added to objects for which it is impractical to deliver the entire list of changes via notifications.

The various embodiments of the present invention result in a lower level of network traffic, leading to improved responsiveness of the systems at issue when synchronizations are being performed. Implementers can also design their own algorithms to decide when a desired threshold is reached, and the various embodiments, when implemented, also result in a lower level of memory consumption. The various embodiments can be used in UPnP/Digital Living Network Alliance (DLNA) products that support content synchronization.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an overview diagram of a system within which the present invention may be implemented;

FIG. 2 is a perspective view of a mobile telephone that can be used in the implementation of the present invention;

FIG. 3 is a schematic representation of the telephone circuitry of the mobile telephone of FIG. 2; and

FIG. 4 is a flow chart showing the implementation of one embodiment of the present invention.

### DETAILED DESCRIPTION OF THE PREFERRED EMBODIMENTS

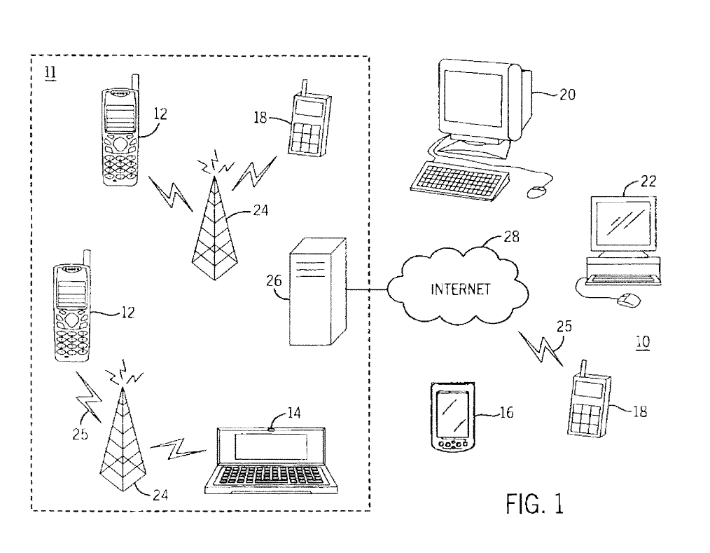

FIG. 1 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

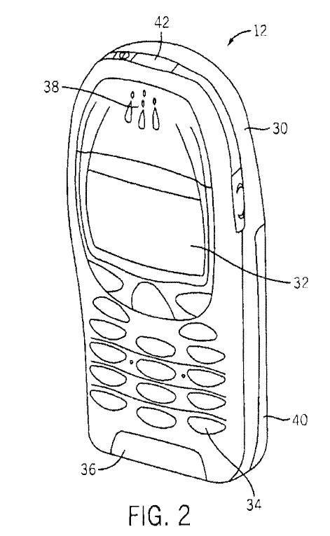

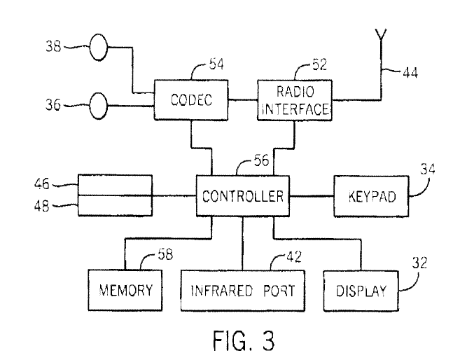

FIGS. 2 and 3 show one representative mobile telephone 12 within which the present invention may be implemented. It should be understood, however, that the present invention is not intended to be limited to one particular type of mobile telephone 12 or other electronic device. The mobile telephone 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56, a memory 58 and a battery 80. Individual circuits and elements are all of a type well known in the art, for example in the Nokia range of mobile telephones.

Various embodiments of the present invention provide a system for improved synchronization with regard to changes in a CDS media library. According to the various embodiments, a new property is added to the LastChange state variable. This new property triggers a control point to browse and search in order to obtain a complete list of changes. This trigger is only added to objects for which it is impractical to deliver the entire list of changes via notifications.

The objects stored in a CDS are organized in containers in a manner similar to the folders/directory arrangement in a file system. The various embodiments of the present invention involves a method for reducing the size of the LastChange state variable by limiting the published changes in a CDS container sub-tree.

An implementation of one particular embodiment of the present invention is as follows. When there are major changes in a container sub-tree, the CDS implementation includes in the LastChange state variable an element that corresponds to the root container of the sub-tree. An additional, optional, Boolean property can be included in the ObjectCreate, ObjectModified or ObjectDeleted elements. This property is referred to herein as the sub-treeChange property. This property can trigger subscribers to use other mechanisms for finding a complete list of changes in the sub-tree. For example, the subscribers can use either CDS:Browse( ) or CDS:Search( ) for this purpose.

The container root of the changed sub-tree can have one of the following elements attached in the LastChange:
ObjectCreated, ObjectCreated@sub-treeChange=“1” This element indicates that the container and its sub-tree are newly created. In such cases, the subscribers still may need to browse the container, etc., in order to retrieve the complete structure of the new container.
ObjectDeleted, ObjectDeleted@sub-treeChange=“1” This element indicates that the container and its entire sub-tree was deleted.
ObjectModified, ObjectModified@sub-treeChange=“1” This element indicates that the container was modified. Additional actions are needed for retrieving the complete list of changes under the container.

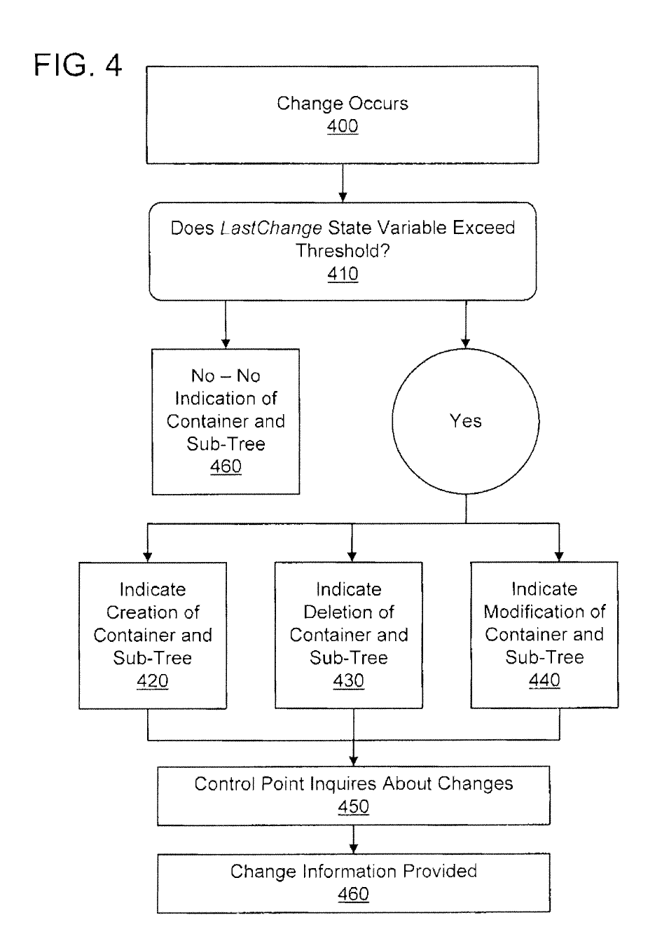

The behaviour presented herein can be applied whenever the changes in a CDS container sub-tree cause the LastChange variable to grow over a certain threshold. Implementers have the freedom to decide when the threshold is reached. FIG. 4 is a flowchart showing the process by which various embodiments of the present invention may be implemented. At 400 in FIG. 4, at least one object in a CDS media library changes. As discussed previously, this can comprise an object being created, an object being deleted, or an object being modified. At 410, it is determined whether the change represented in 400 causes the LastChange state variable for the CDS library to exceed a certain threshold. If the change causes the variable to exceed the threshold, then the LastChange state variable is transferred to at least one control point with an indication of the sub-tree container where the change occurred, as well as an appropriate indication of what has occurred to the particular container. This indication can comprise an indication that a container and its sub-tree has been newly created (420), a container and its sub-tree has been deleted (430) or that a container has been somehow modified (440). In each of these cases, the control point can update its own records regarding the CDS media library and inquire as to the changes that occurred at 450, with the additional information being provided at 460. In the event that the original change in the object does not cause the LastChange state variable to exceed the designated threshold, then the LastChange state variable can be transmitted at 460 without any indication as to the sub-tree that has been altered, or the state variable transmission can be delayed until a regularly scheduled time, for example. It is also possible for the sub-tree to always be designated in certain embodiments.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of providing updated information about content in a content directory service (CDS) media library, comprising:
observing a change in a container of the CDS media library; and
at least selectively sending to a control point device an indication regarding a type of change that has occurred in the container.

2. The method of claim 1, wherein the indication indicates that the container and its respective sub-tree have been deleted from the CDS media library.

3. The method of claim 1, wherein the indication indicates that the container and its respective sub-tree have been added to the CDS media library.

4. The method of claim 1, wherein the indication indicates that the container in the CDS media library has been modified.

5. The method of claim 1, further comprising:
receiving a request from the control point device for additional information concerning the particular changes that have occurred in the container; and
in response to the request, providing the additional information to the control point device.

6. The method of claim 1, further comprising determining whether the change in the container causes a LastChange variable to exceed a given threshold, and wherein the indication specifically indicates the container to which the change has occurred only if the LastChange variable exceeds the given threshold.

7. A computer program product, embodied in a computer-readable medium, for providing updated information about content in a content directory service (CDS) media library, comprising:
computer code for observing a change in a container of the CDS media library; and
computer code for at least selectively sending to a control point device an indication regarding a type of change that has occurred in the container.

8. The computer program product of claim 7, further comprising computer code for determining whether the change in the container causes a LastChange variable to exceed a given threshold, and wherein the indication regarding the type of change that has occurred in the container is sent only if the LastChange variable exceeds the given threshold.

9. An apparatus, comprising:
a processor; and
a memory unit communicatively connected to the processor and including:
computer code for observing a change in a container of a content directory service (CDS) media library; and
computer code for at least selectively sending to a control point device an indication regarding a type of change that has occurred in the container.

10. The apparatus of claim 9, wherein the indication indicates that the container and its respective sub-tree have been deleted from the CDS media library.

11. The apparatus of claim 9, wherein the indication indicates that the container and its respective sub-tree have been added to the CDS media library.

12. The apparatus of claim 9, wherein the indication indicates that the container in the CDS media library has been modified.

13. The apparatus of claim 9, wherein the memory unit further comprises:
computer code for receiving a request from the control point device for additional information concerning the particular changes that have occurred in the container; and
computer code for, in response to the request, providing the additional information to the control point device.

14. The apparatus of claim 9, wherein the memory unit further comprises computer code for determining whether the change in the container causes a LastChange variable to exceed a given threshold, and wherein the indication specifically indicates the container to which the change has occurred only if the LastChange variable exceeds the given threshold.

15. A system, comprising:
a control point device; and
a server including a content directory service (CDS) media library, the server configured to:
observe a change in a container of the CDS media library; and
at least selectively send to the control point device an indication regarding a type of change that has occurred in the container.

16. The system of claim 15, wherein the server is further configured to determine whether the change in the container causes a LastChange variable to exceed a given threshold, and wherein the indication specifically indicates the container to which the change has occurred only if the LastChange variable exceeds the given threshold.

17. A method of updating a stored representation of a content directory service (CDS) media library, comprising:
receiving from a server an indication regarding a type of change that has occurred in a container of the CDS media library; and
in response to the received indication, requesting additional information from the server concerning particular changes that have occurred in the container.

18. The method of claim 17, wherein the indication indicates that the container and its respective sub-tree have been deleted from the CDS media library.

19. The method of claim 17, wherein the indication indicates that the container and its respective sub-tree have been added to the CDS media library.

20. The method of claim 17, wherein the indication indicates that the container in the CDS media library has been modified.

21. A computer program product, embodied in a computer-readable medium, comprising computer code for performing the processes of claim 17.

22. An apparatus, comprising:
a processor; and
a memory unit communicatively connected to the processor and including:
computer code for processing a received indication from a server regarding a type of change that has occurred in a container of a content directory service (CDS) media library; and
computer code for requesting additional information from the server concerning particular changes that have occurred in the container.

23. The apparatus of claim 22, wherein the indication indicates that the container and its respective sub-tree have been deleted from the CDS media library.

24. The apparatus of claim 22, wherein the indication indicates that the container and its respective sub-tree have been added to the CDS media library.

25. The apparatus of claim 22, wherein the indication indicates that the container in the CDS media library has been modified.
